(19) United States
(12) Patent Application Publication
(10) Pub. No.: US 2006/0071468 A1
(43) Pub. Date: Apr. 6, 2006

(54) Method and apparatus for verifying the authenticity of bank notes

(76) Inventor: Barry Marsden, LANCASHIRE (GB)

Correspondence Address: DENNISON, SCHULTZ, DOUGHERTY & MACDONALD, 1727 KING STREET, SUITE 105, ALEXANDRIA, VA, 22314, US

(21) Appl. No.: 10/535,663

(22) PCT Filed: Nov. 19, 2003
(86) PCT No.: PCT/GB03/05024

§ 371 Date: May 19, 2005

(30) Foreign Application Priority Data
Nov. 19, 2002 (GB) 0227056.9
Jan. 24, 2003 (GB) 0303814.8
Apr. 22, 2003 (GB) 0309062.8

(51) Int. Cl. B42D 15/00

(52) U.S. Cl. 283/57

(57) ABSTRACT

A method and apparatus for verifying the authenticity of bank notes or other notes having a security thread embedded therein, said apparatus comprising a scanning unit comprising at least one light source disposed opposite to at least one detector, wherein said at least one detector outputs a signal responsive to the transmitted light. As the bank note is swiped between the light source and detector the resultant output is processed, digitally encoded and correlated with stored characteristics corresponding to the transmission properties of an authentic bank note. These stored characteristics corresponding to the transmission properties of an authentic bank note are obtained by calibrating the apparatus with an authentic bank note.

This invention relates to a method and apparatus for verifying the authenticity of bank notes or other notes. In particular, this invention relates to a method and apparatus for verifying the authenticity of bank notes having a security thread embedded therein. Said method and apparatus enabling both small businesses and individuals to determine the authenticity of bank notes when they are taken or received as payment for goods or services and also enabling financial institutions and banks to determine the authenticity of large volumes of bank notes.

The counterfeiting and passing off of counterfeit bank notes is now generally recognised throughout the world as being a major problem, particularly for the EU and western economies. The problems lie in the fact that the criminal elements within society have access to sophisticated scanning and printing equipment, sufficient for the purposes of producing very accurate counterfeit bank notes.

The security aspects of genuine bank notes vary from country to country, but in the main rely on (1) the feel of the paper; (2) the colour and quality of the printing on the note; (3) variable holograms; (4) security thread; (5) a discernable watermark, as in the case of Bank of England notes which bear the head of Her Majesty The Queen; (6) unseen patterns that only become visible when viewed under ultraviolet or red lamps; and (7) a special type of varnish that is used to give a bank note that special feel and to extend the life period of the note.

With the notable exception of the security thread (4), the above detailed measures present little or no problem to established counterfeiting rings. In particular, high quality printing equipment, in some cases identical to those used for the manufacture of genuine notes, are purchased to be used, so as to give the continuity and quality demanded. Inks used in genuine notes are determined by the use of spectrometer or other methods of analysis and it is then a simple matter of replication; a similar pattern emerges in respect of the varnish used. The addition of a watermark is also a relatively simple procedure. Availability of huge funding, which is the case, allows the counterfeiters to acquire paper which is virtually identical to the paper used in genuine notes, but most certainly after varnish treatment, and it would take an expert to determine the authenticity of the bank note.

The only problem that confronts counterfeiters, and will continue to do so, is the implementation of the security thread which runs in the vertical plane through most bank notes. More and more countries are turning to the use of the security thread as a means of being able, at first hand, to distinguish counterfeit from genuine notes.

These security threads are generally manufactured from metal, ceramics, polymers, plastics or a combination of any of these. Printed onto the thread are details of the issuing bank and the denomination of the value of the note. Not all information is printed in a similar manner, as in the case of certain ranges of US dollars, wherein the printing is direct and alternatively opposed. Italian bank notes have two variable width strips in notes. There are several variations used, but, in the main, the method is a simple single strip in the vertical plane.

Banks throughout the world have in the past tended to present a united front that the quantity of counterfeit notes in circulation was so small as to be non-existent, but this is now known not to be true. Publications internationally, throughout Europe, USA and Africa, report alarming rises in the volumes of counterfeit notes seized or recovered and law enforcement agencies throughout the world are now alerted to this ever-increasing problem. Banks themselves admit to having committed offences of having passed off counterfeit notes, simply because notes passing over the counters are not checked. In some instances, as with post offices, volumes can be very high, and in the main, the re-issuance of counterfeit notes have come from companies involved in collecting large volumes of cash from banks and making up cash payrolls.

In 2001, the Bank of England admitted that as much as 1% of all notes in circulation in the United Kingdom could be considered to be counterfeit, and that at any given time, some £27 billion was in circulation.

The United States also admits to major counterfeiting problems and confirms that organised crime, with their established associates, are responsible for the spread of counterfeit notes throughout the world.

More recently, with the introduction of the Euro, the crime syndicates were presented with an opportunity to introduce large volumes of counterfeit Euros, not only in Europe, but as the Euro is becoming accepted internationally, so the opportunities are increasing. The major problems associated with the Euro are that despite appearing similar, there are notable differences with each country having incorporated its own designs, so we now have some teens of designs on similar notes, which nobody recognises immediately, nor could they be expected to do so. In many countries throughout the world, the general public and indeed sections of commerce and industry have absolutely no idea what a Euro looks or feels like, nor what they should be looking for.

Interpol and the European Monetary Institute admit to the growing problem of counterfeiting and the need to effect an immediate response in an effort to reduce and eventually stop the printing of counterfeit bank notes. In an attempt to overcome the above mentioned problems, a number of techniques are currently available to verify the authenticity of bank notes, which range from the very simple ink pen that reacts to known chemicals in the note, to ultra violet scanners and sophisticated, yet very expensive, photosynthesis-based units.

The pens and scanners working on the ultra violet detection method are by far the most widely used units, simply because of their cost and ease of use, but in themselves they are not a solution as the counterfeiters, by using a variety of fish oils and other reactive oils, have by-passed this method of testing. Other drawbacks from using this type of product are that the notes ultimately become defaced.

A common method used in many establishments is for the till operator to tear a bank note through the security thread to see whether or not the thread runs through the middle of the note. This again is despoiling the note, and most certainly is frowned upon by banks.

The Bank of England does issue guidelines for detecting counterfeit notes in a pamphlet advising the public at large as to how to detect a counterfeit note. This is simply based on (a) raised printing; (b) the colours of the note; (c) the quality of paper; (d) the presence of a watermark in the appropriate place; and (e) the quality of printing.

For the benefits of the above to be obvious, the viewer must have 20/20 vision, not be colour blind, have sensitive fingers and most importantly, the note must be felt and viewed in good light. These collective circumstances are very rarely in evidence.

Photosynthesis equipment is both expensive and time consuming to use and could not be made readily available to small shopkeepers and in busy supermarket stores which are a primary source for the passing off of counterfeit notes, there is most certainly not the space available, nor has the till operator time to use same.

It is an object of the present invention to provide a small, highly reliable, cost effective unit as a means of reducing the above mentioned counterfeit problem; one which is easily used by anyone, without any special training, having the capability, without further question of accurately determining the authenticity of any bank note. The present invention enabling small businesses and individuals to accurately and instantaneously determine the authenticity of bank notes when they are taken or received as payment for goods or services.

It is a further object of the present invention to provide a method and apparatus for determining the authenticity of a large volume of bank notes. The second part of the problem lies with receiving or dealing in large volumes of bank notes, where it would be virtually impossible, through lack of time, cost and other relevant matters, to examine every individual note and determine its authenticity.

The need for speed and simplicity in being able to check the authenticity of a large volume of bank notes is paramount in providing the financial institutions and banks with a cost effective method of being able to examine thousands of notes in minutes and accurately determine whether the bank note is genuine. In this way, financial institutions and banks would (a) be able to readily identify the source from which the funds came; (b) remove and retain counterfeit notes, thereby preventing their re-circulation to the general public; (c) provide valuable information to law enforcement agencies; and (d) enhance international confidence in certain currencies.

There does already exist certain technology incorporating photosynthesis used for the purpose of scanning bank notes accurately, but again this is slow, time-consuming, disproportionately expensive, and too large for use in confined spaces.

According to the present invention there is provided a method for verifying the authenticity of a bank note or other note having a security thread embedded therein, comprising the steps of:

illuminating a first section of said bank note using a first light source;

sensing with a first detector light transmitted through said first section and generating a first signal responsive to said transmitted light;

scanning said bank note relative to said first section; and

comparing the level of correlation between said first signal responsive to said transmitted light and stored characteristics corresponding to the transmission properties of an authentic bank note.

Also according to the present invention there is provided an apparatus suitable for verifying the authenticity of a bank note or other note having a security thread embedded therein, comprising:

a first light source disposed opposite to a first detector, wherein said first detector outputs a first signal responsive to the transmitted light, said first light source and said first detector being disposed such that said bank note can pass therebetween;

encoding means for digitally encoding the output of said first detector; and

processing means for comparing the level of correlation between said digitally encoded output and stored characteristics corresponding to the transmission properties of an authentic bank note.

Preferably, the bank note is scanned along its long axis; the security thread embedded therein being disposed along the short axis of the note. In use, the first light source and first detector are located in separate pillars which form a slot through which said bank note can pass. In use, the bank note is swiped in a similar manner to methods used to swipe credit cards or the like.

Further, in use, a second light source and a second detector are provided so that light is transmitted through a second section of the bank note, which generates a second signal responsive to said transmitted light. The light sources and detectors being dimensionally opposed to each other such that light emanating from each of the light sources is received by each of the opposing detectors. Each of said light sources and each of said detectors being positioned substantially vertically in the same plane as the security thread. Two sets of light sources and detectors may be used because the background noise, such as text and other printed material on the bank note, generally do not follow vertical lines, while the security thread does.

As the bank note is scanned, the printing contained in the security thread, or the actual metallic thread itself, restricts the full flow of transmitted light from said light sources to said detectors. The more printing and the heavier the density of inks or dyes used in the security thread, less transmitted light passes through the first and second sections of the bank note, thus generating said first and second signals responsive to said transmitted light. In use, said first and second signals, or pulses, obtained from said detectors are digitally encoded and summed prior to comparing the level of correlation between said such and stored characteristics corresponding to the transmission properties of an authentic bank note. Said summation may be implemented using software stored in the processing means.

Further, in use, prior to comparing the level of correlation between the digitally encoded output of the detectors and stored characteristics corresponding to the transmission properties of an authentic bank note, the digitally encoded output is checked to ensure that the resultant pulse meets a required threshold. Preferably, said required threshold is based on the ratio of the resultant pulse width to pulse rise time obtained from the digitally encoded output.

Further preferably, the stored characteristics corresponding to the transmission properties of an authentic bank note are obtained by firstly passing an authentic note through the light source/detector pair which allows it to measure its characteristics, which are then subsequently stored in a non-volatile memory. Said stored characteristics corresponding to the transmission properties of an authentic bank note are based on a combination of the resultant rise time, fall time, pulse amplitude, and pulse width obtained from the digitally encoded output, and, in use, such calibration need only be carried out once. When calibrated, it is the peak amplitude of the resultant digitally encoded output that is compared with the calibration levels of an authentic note. Preferably, the non-volatile memory may comprise any suitable solid state memory.

In use, said first and second light sources are infrared emitters, such as infrared diodes, and said first and second detectors are infrared photo detectors. Said processing means may be provided by any suitable microprocessor unit. Furthermore, a visual and audible alarm may be provided, being activated if the digitally encoded output and said stored characteristics corresponding to the transmission properties of an authentic bank note do not correlate.

Further according to the present invention there is provided an apparatus for verifying the authenticity of a large volume of bank notes or other notes each having a security thread embedded therein, comprising:

a bank note transfer route for transferring each of said bank notes;

a scanning unit for obtaining various characteristics of each of said bank notes, said scanning unit comprising at least one light source disposed opposite to at least one detector, wherein said at least one detector outputs a signal responsive to the transmitted light, said at least one light source and said at least one detector being disposed such that each of said bank notes can pass therebetween;

a processing means for receiving and digitally encoding the output of said at least one detector and comparing the level of correlation between said digitally encoded output and stored characteristics corresponding to the transmission properties of an authentic bank note; and

selection means for sorting authentic bank notes and un-correlated bank notes.

In use, said bank note transfer route may comprise a floating level tray and feeder wheel mechanism to ensure continuous progression of bank notes through the scanning unit. Each of said bank notes is transferred substantially in the horizontal plane through the bank note transfer route, scanning unit and into selection means. Preferably, said scanning unit and said processing means are located in a secure moulded unit to prevent unauthorised access by personnel.

Further preferably, said selection means further comprises a conveyor mechanism, authentic bank note tray and counterfeit bank note tray. Each of said trays may be provided with electronic sensors allowing the number of bank notes falling into each tray to be counted.

It is believed that the method and apparatus for verifying the authenticity of bank notes in accordance with the present invention at least addresses the problems outlined above. In particular, the advantages of the present invention are that a method and apparatus for verifying the authenticity of bank notes is provided. Said method and apparatus enabling both small businesses and individuals to determine the authenticity of bank notes when they are taken or received as payment for goods or services and also enabling financial institutions and banks to determine the authenticity of large volumes of bank notes. In use, a small, highly reliable, cost effective unit is provided which accurately and instantaneously determines the authenticity of bank notes.

It will be obvious to those skilled in the art that variations of the present invention are possible, and it is intended that the present invention may be used other than specifically as described herein.

A specific non-limiting embodiment of the invention will be described by way of example and with reference to the accompanying drawings in which:

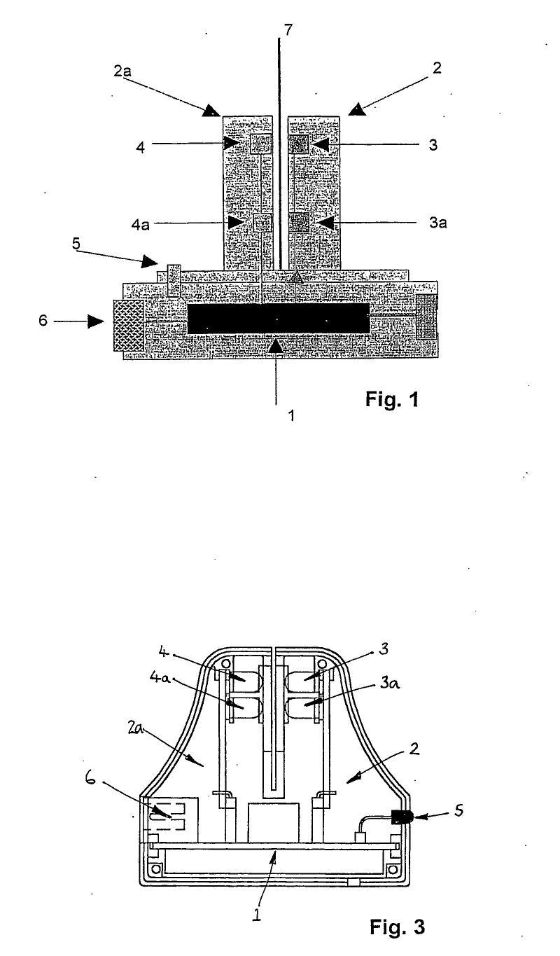

FIG. 1 is a schematic diagram of the apparatus for verifying the authenticity of bank notes in accordance with the present invention.

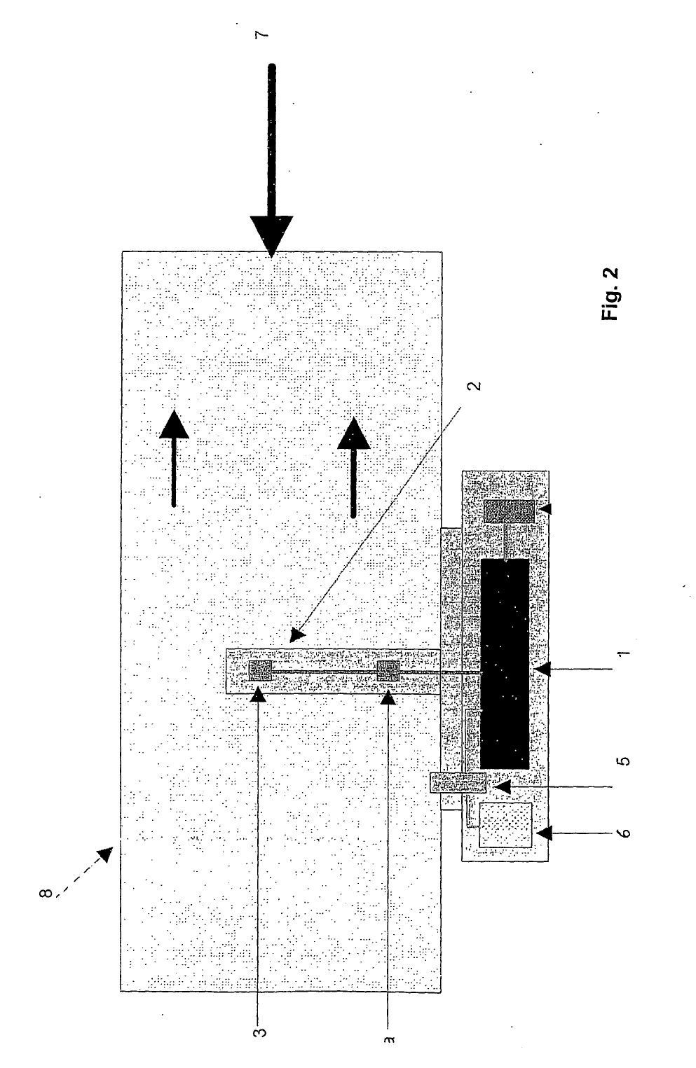

FIG. 2 is a further schematic diagram of the apparatus for verifying the authenticity of bank notes in accordance with the present invention, having further detail of the security thread embedded in the note.

FIG. 3 shows a section of the end elevation of the present invention.

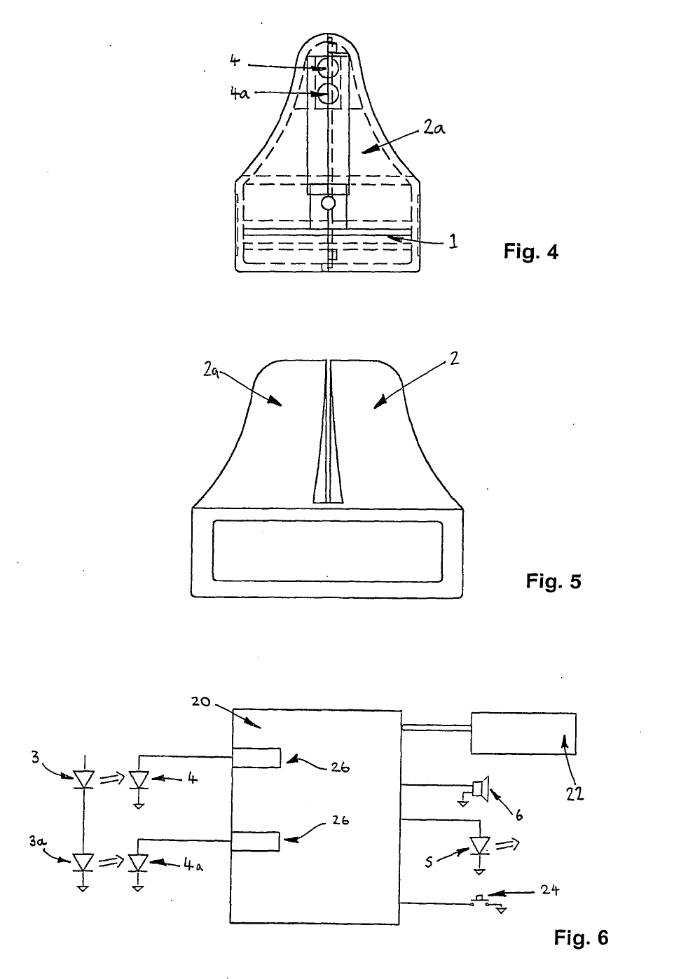

FIG. 4 shows a section of the side elevation of the present invention.

FIG. 5 illustrates an end elevation of the present invention.

FIG. 6 shows schematically the detection electronics and associated memory required for performing the authenticity verification.

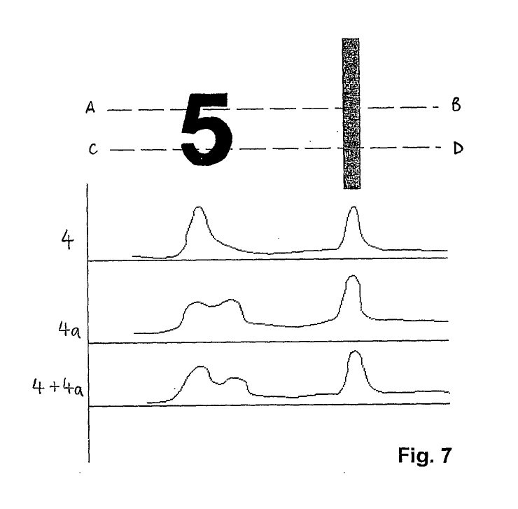

FIG. 7 details the output of the infrared receivers in response to a bank note with a security thread embedded therein being passed thereover.

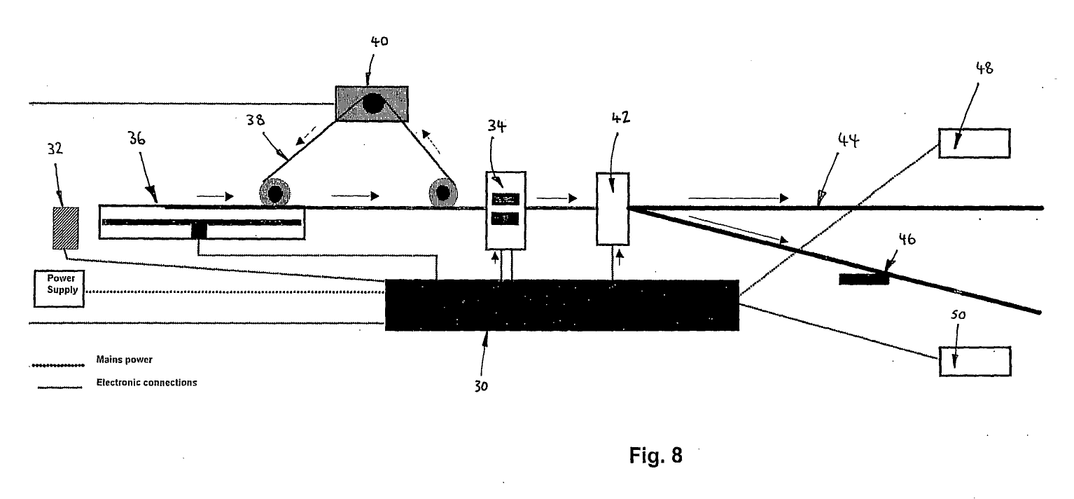

FIG. 8 shows how the present invention can be implemented to authenticate large volumes of bank notes.

Referring now to the drawings, the implementation of the present invention is illustrated in FIGS. 1 and 2. In use, the apparatus scans bank notes 7 of all denominations from various countries and immediately determines the authenticity of the note 7 by means of analysing the amount of light passing through the securing thread 8 encompassed in the bank note 7 and comparing the readings of light registered with the receivers 4, 4a to the transmission properties of an authentic bank note.

The unit has a base with extended pillars 2, 2a through which a bank note 7 can be easily swiped in a similar manner to the methods used to swipe credit cards. The angle at which the pillars 2, 2a extend from the base of the unit would normally, but not essentially, be at an angle of around 90° to the horizontal plane. The unit can be manufactured from any plastics or similar such suitable material.

The unit incorporates a printed circuit board (PCB) 1, incorporating and interconnecting the various electronic components required for the storage of information and, when necessary, for the immediate comparison of information which is received from detectors 4, 4a connected to the PCB 1, and mounted in pillars 2, 2a.

Also mounted in the vertical pillars 2, 2a of the unit are emitters 3, 3a. The emitters 3, 3a and receivers 4, 4a are dimensionally opposed to each other such that light emanating from the emitters 3, 3a is received by the opposing receivers 4, 4a. The emitters 3, 3a are diametrically opposed at variable distances from receivers 4, 4a and electrically connected to the PCB 1 at an angle so as to provide a situation whereby the light emanating from the emitters 3, 3a is adequately received by the receivers 4, 4a. It should also be noted that whilst two pairs of emitters 3, 3a and receivers 4, 4a are described, this is in no way intended to be limiting as, in use, it may be the case that only one pair or more than two pairs of emitters and receivers are used.

The unit has a slot which is formed between the pillars 2, 2a, housing the emitters 3, 3a and receivers 4, 4a, as shown in FIG. 1; the slot being between pillar 2 and pillar 2a along the vertical plane, so as to allow a bank note to pass therebetween. Further detail of the slot is shown in FIG. 5 which shows an end elevation of the preferred embodiment.

The security thread 8 contained in each bank note 7 is produced by means of a secret process and is considered to be virtually impossible for counterfeit rings to copy or emulate. Each security thread 8 is different, some are simply metallic, others could be polymer, plastic or a combination of materials. Upon each is generally, but not always, printed the issuing bank and the denomination of the bank note. The position of security thread 8, is by way of example only as the positioning and location of the thread differs from note to note. Security threads 8 also vary in width, but in all known cases, are believed to run in the vertical plane.

The printing contained in each thread 8 (not shown) is repetitive throughout the thread and it is the positioning and amount of printing on the thread that restricts the full flow of emitted light from the emitters 3, 3a to the receivers 4, 4a. In use, the quantity and quality of emitted light received by the receivers 4, 4a is processed according to FIG. 6. The more printing and the heavier the density of inks or dyes used in the security thread 8, the less the light received by the receivers 4, 4a.

The scanning of the security thread 8 as it is passed through the slot between pillars 2, 2a is instantaneous and the information obtained is fed to and processed by a microchip on the PCB 1 for comparative purposes to known criteria. The comparison is instantaneous and if the scanned parameters comply with known parameters of genuine notes, then a signal is passed to a light emitting diode (LED) 5 mounted in the casing of the unit, and simultaneously to a small audible device 6. The two activated together giving information both visually and audibly that the scanned bank note can be considered as genuine. In use, power to the PCB 1 can be supplied to the unit from the mains supply or batteries.

Further detail of the positioning of the emitter/receiver pairs and the configuration of the pillars and slot are depicted in FIGS. 3 to 5. In particular, FIG. 3 shows a section of the end elevation of the present invention and details of the configuration of the emitter 3, 3a and receiver 4, 4a arrangement extending from the base of the PCB 1. FIG. 4 shows a section of the side elevation of the present invention, and FIG. 5 details an end elevation of the encapsulated unit, with the slot for the bank note being clearly shown.

FIG. 6 shows schematically how the detection electronics and associated memory perform the authenticity verification described above. In use, the circuit consists of a single chip microprocessor unit (MPU) 20, with external non-volatile memory 22 for calibration data storage.

In use, light from the emitters 3, 3a, which is produced by a pair of infrared diodes, shines through the slot, passes through the note being tested and is picked up by the receivers 4, 4a, which are generally infrared photo detectors. As the security threaded passes the slot, the light is blocked and a pulse results from the photo detectors. MPU 20 measures the pulse shape obtained through the two analogue ports 26.

In a preferred embodiment, the two signals obtained from the photo detectors are averaged in software to provide a single signal. Two photo detectors are used because the background noise, such as text and other printed material on the bank note, generally do not follow vertical lines, while the security thread does. Averaging the two photo detector signals effectively doubles the strip amplitude and halves the printed material amplitude giving a significant improvement in signal to noise ratio. Crosstalk between the two pairs of emitters 3, 3a and receivers 4, 4a add to the averaging effect and reduces the vertical resolution, and further aiding the rejection of printed material.

To illustrate this, sample pulses obtained from receivers 4, 4a are shown in FIG. 7. The output of receiver 4 is shown following the line A-B which first passes over textual information in the form of the numeral ‘5’ embossed on the security thread, and then a solid, possibly, metallic security thread. The output of receiver 4a is also shown following the line C-D. The resultant pulses obtained from the separate outputs of receiver 4 and receiver 4a are shown, along with the averaged signal of receivers 4 and 4a which is performed by the MPU 20, after encoding the separate analogue signals through the analogue ports 26.

In a preferred embodiment, it is the digitally averaged output of receivers 4 and 4a which is used when comparing the level of correlation between such and previously stored characteristics which correspond to the transmission properties of an authentic bank note. When a note is swiped through the slot, the resultant digitally averaged output of receivers 4 and 4a is checked to ensure that a valid pulse has been obtained. The first characteristic to be checked is the rising edge. As shown in FIG. 7, a security thread produces a significantly faster rise time than printed text due partly to the averaging process and partly due to the sharper metallic edge. Any rise times below a set threshold are subsequently ignored, and the tri-coloured LED 5 will display an amber signal.

Once a valid rise has been detected its amplitude must be greater than a set threshold otherwise it again will be ignored. When the above conditions of rise time and pulse amplitude have been met the rise time, maximum pulse height, fall time and width are all measured.

Now the software can verify if this is a valid security strip by comparing the measured parameters against known characteristics and calibration data. Clearly, pulse width and rise time are dependent on the speed the note passes the receivers 4, 4a. The ratio of pulse width to rise time is used to determine the actual security thread width. If a security thread is wider than a threshold value it is rejected.

The peak amplitude is compared with the calibration levels. When the unit is un-calibrated, any level between maximum dark and blank paper is accepted. When calibrated, a reduced range of amplitudes are accepted. If the peak pulse amplitude is outside the un-calibrated or calibrated levels it is rejected. When all the above conditions are met, the note is verified as genuine. The LED 5 shows the note type accompanied by a bleep. If the note is counterfeit there is no LED 5 flash or bleep from the audible device 6.

Calibrating the unit is achieved by passing a genuine note through the emitter/receiver pair which allows it to learn the characteristics which are stored in the non-volatile memory 22. Calibration need only be carried out once; the type being displayed on the coloured LED 5 on power-up.

Switch 24 is used to enter calibration mode, and calibration determines the valid peak amplitude of the security thread signal from a genuine note. The minimum and maximum valid amplitude is determined and stored in non-volatile memory 22. This then differentiates between genuine security threads and those of counterfeit notes.

It also determines the type of note, which is displayed when a security thread is found. When un-calibrated, all valid note types are accepted and the LED 5 shows amber, but the ability to determine counterfeits is reduced. If a US dollar note is used to calibrate, the LED 5 shows green, any other note shows red.

In use, a 5V regulator allows the unit to run from battery or mains supply. Additionally, the emitters 3, 3a may be switched off when no notes are in place to reduce the power consumption when run from batteries. The invention is a sealed unit and is impervious to climatic conditions including high variances of temperatures.

FIG. 8 shows how the present invention can be implemented to authenticate large volumes of bank notes, suitably for financial institutions and banks, at a speed normally associated with units that can only be used to count bank notes and verify accurately the amounts counted.

As described previously, a processor 30 and emitter/receiver pair 34 perform the comparison based on the resultant transmission signals obtained as the security thread in the bank note passes therethrough. In use, the processor 30 and emitter/receiver pair 34 are contained in a moulded case or unit of plastic (not shown) or similar such materials suitable for the purpose and suitably sealed in an appropriate manner as to prevent entry or intrusion into the system other than by authorised persons and all items within the moulded case are securely affixed thereto in a suitable appropriate manner.

At the front of the unit is, for example, positioned an open recessed area. In this recessed area is fixed a floating level tray 36 substantially in the horizontal plane. The floating level tray 36 is positioned so as to be capable of receiving a predetermined number, as an example 500 bank notes, these being placed lengthwise pointing towards the central area of the unit.

The bank notes do not have to be placed in the floating level tray 36 with all notes facing either up or down; simply placed in the tray and centralised. The floating level tray 36 has mechanisms placed under same which automatically raises the tray to its correct feeding position under fixed speed feeder wheel 38 so as to maintain contact between the bank notes and the wheel at the correct pressure.

The floating level tray 36 would have automatically adjusting side positioners so as to keep the bank notes properly positioned. These would automatically come into action once the start button 32 is pressed. A signal would be sent to electronic mechanisms within the floating level tray 36 to bring this into effect so as to secure the pile of bank notes at the correct level under feed wheel 38.

Once in the correct position, the feed wheel 38 sends a signal to the processor 30 which in turn activates the emitter/receiver pairs 34 and engages the electronic drive motor 40 which turns the fixed speed feeder wheel 38; the wheel being manufactured from any suitable material capable of registering a firm contact with the top bank note resting in the floating level tray 36. Feeder drive wheel 38 rotates anti-clockwise and feeds the bank note onto the bank note positioning tray (not shown) which has its own overhead drive wheel, driven from the electronic drive motor 40 working in unison with the fixed speed feeder wheel 38 to ensure continuous progression of the bank note through the emitter/receiver pairs 34.

The emitter/receiver pairs 34 could be single, double or triple units, connected either singly, doubly or in triplicate to the processor 30 and so positioned within the unit as to be capable of scanning information contained in the security thread of a bank note. Bank notes pass through one, two or three sets of emitter/receiver pairs 34 as may be the case required. Having scanned the bank note as it passes through the emitter/receiver pairs 34, the processor makes an instantaneous comparison with the particulars of a genuine bank note, as hereinbefore described.

If the scanned information is deemed to be identical to that of a genuine note, a signal is sent from the processor 30 to the electronic note switch mechanism 42 dependent upon the authenticity of the scanned note. The electronic note switch mechanism 42 will operate a tray mechanism allowing the authentic notes to slide into the authentic note tray 44; counterfeit notes, or notes having been found as not complying to required standards are similarly fed into the counterfeit note tray 46. In use, both the aforementioned trays 44, 46 are fitted with electronic sensors thereby allowing the number of notes falling into each tray to be counted and the numbers displayed on displays 48 and 50, respectively.

On completion of the required tasks, the processor automatically switches off after a delay time of thirty seconds with an alarm sounding to indicate completion of task.

Various alterations and modifications may be made to the present invention without departing from the scope of the invention. For example, although particular embodiments refer to utilising infrared emitters 3, 3a and receivers 4, 4a, this is in no way intended to be limiting as, in use, the present invention may be implemented using any suitable form of incident radiation. Additionally, although particular embodiments refer to the authentication of bank notes, again, this is in no way intended to be limiting as, in use, the present invention may be implemented to authenticate any note or document which has a security thread embedded therein, i.e. gilts, bond certificates, cheques, tickets etc.

1. A method for verifying the authenticity of a bank note or other note having a security thread embedded therein, comprising the steps of:
illuminating a first section of said bank note using a first light source;
sensing with a first detector light transmitted through said first section and generating a first signal responsive to said transmitted light;
scanning said bank note relative to said first section; and
comparing the level of correlation between said first signal responsive to said transmitted light and stored characteristics corresponding to the transmission properties of an authentic bank note.

2. A method as claimed in claim 1, wherein said security thread is disposed along the short axis of said bank note.

3. A method as claimed in claim 1, wherein said illuminating step further comprises illuminating a second section of said bank note using a second light source.

4. A method as claimed in claim 3, wherein said first and second light sources are positioned substantially vertically in the same plane as said security thread.

5. A method as claimed in claim 3, wherein said sensing step further comprises sensing with a second detector light transmitted through said second section of said bank note and generating a second signal responsive to said transmitted light.

6. A method as claimed in claim 5, wherein said first and second signals are summed prior to said comparing step.

7. A method as claimed in claim 1, wherein said stored characteristics corresponding to the transmission properties of an authentic bank note are firstly obtained by scanning an authentic bank note having a security thread embedded therein.

8. A method as claimed in claim 7, wherein said stored characteristics corresponding to the transmission properties of an authentic bank note are based on a combination of the resultant rise time, fall time, pulse amplitude, and pulse width obtained from said scanning step.

9. A method as claimed in claim 1, wherein said stored characteristics corresponding to the transmission properties of an authentic bank note are retained in a non-volatile memory.

10. A method as claimed in claim 1, wherein said comparing step further comprises the step of checking whether said first signal responsive to said transmitted light from said scanning step meets a required threshold prior to comparing the level of correlation.

11. A method as claimed in claim 10, wherein said required threshold is based on the ratio of the resultant pulse width to pulse rise time obtained from said scanning step.

12. An apparatus suitable for verifying the authenticity of a bank note or other note having a security thread embedded therein, comprising:
a first light source disposed opposite to a first detector, wherein said first detector outputs a first signal responsive to the transmitted light, said first light source and said first detector being disposed such that said bank note can pass therebetween;
encoding means for digitally encoding the output of said first detector; and
processing means for comparing the level of correlation between said digitally encoded output and stored characteristics corresponding to the transmission properties of an authentic bank note.

13. An apparatus as claimed in claim 12, further comprising a second light source disposed opposite to a second detector, wherein said second detector outputs a second signal responsive to the transmitted light, said second light source and said second detector being disposed such that said bank note can pass therebetween.

14. An apparatus as claimed in claim 13, wherein said first and second detectors are positioned substantially vertically in the same plane as said security thread.

15. An apparatus as claimed in claim 12, wherein said encoding means also digitally encodes the output of said second detector.

16. An apparatus as claimed in claim 15, further comprising summing means for receiving and combining the digitally encoded outputs of said first and second detectors.

17. An apparatus as claimed in claim 12, wherein said stored characteristics corresponding to the transmission properties of an authentic bank note are based on a combination of the resultant rise time, fall time pulse amplitude, and pulse width obtained from said scanning an authentic bank note having a security thread embedded therein.

18. An apparatus as claimed in claim 12, wherein said stored characteristics corresponding to the transmission properties of an authentic bank note are stored in a non-volatile memory.

19. An apparatus as claimed in claim 18, wherein said nonvolatile memory comprises a solid state memory.

20. An apparatus as claimed in claim 13, wherein said first and second light sources are infrared emitters.

21. An apparatus as claimed in claim 13, wherein said first and second detectors are infrared photo detectors.

22. An apparatus as claimed in claim 12, further comprising a visual or audible alarm, being activated if said digitally encoded output and said stored characteristics corresponding to the transmission properties of an authentic bank note do not correlate.

23. An apparatus as claimed in claim 12, wherein said processing means comprises a. microprocessor unit.

24. An apparatus for verifying the authenticity of a large volume of bank notes or other notes each having a security thread embedded therein, comprising:
a bank note transfer route for transferring each of said bank notes;
a scanning unit for obtaining various characteristics of each of said bank notes, said scanning unit comprising at least one light source disposed opposite to at least one detector, wherein said at least one detector outputs a signal responsive to the transmitted light, said at least one light source and said at least one detector being disposed such that each of said bank notes can pass therebetween;
a processing means for receiving and digitally encoding the output of said at least one detector and comparing the level of correlation between said digitally encoded output and stored characteristics corresponding to the transmission properties of an authentic bank note; and
selection means for sorting authentic bank notes and un-correlated bank notes.

25. An apparatus as claimed in claim 24, wherein said bank note transfer route further comprises a floating level tray and feeder wheel mechanism.

26. An apparatus as claimed in claim 24, wherein each of said bank notes is transferred substantially in the horizontal plane.

27. An apparatus as claimed in claim 24, wherein said scanning unit and said processing means are located in a secure moulded unit to prevent unauthorised access by personnel.

28. An apparatus as claimed in claim 24, wherein said selection means further comprises a conveyor mechanism, authentic bank note tray and counterfeit bank note tray.

29. An apparatus as claimed in claim 28, wherein each of said trays are provided with electronic sensors allowing the number of bank notes falling into each tray to be counted.

30. (canceled)

31. (canceled)

32. (canceled)
